(19) United States
(12) Patent Application Publication
(10) Pub. No.: US 2014/0082513 A1
(43) Pub. Date: Mar. 20, 2014

(54) SYSTEMS AND METHODS FOR PROVIDING CONTEXT-SENSITIVE INTERACTIVE LOGGING

(71) Applicant: APPSENSE LIMITED, Warrington (GB)

(72) Inventors: Michael MILLS, Aurora, IL (US); Jonathan WALLACE, Coral Springs, FL (US); Joseph SAIB, Santa Clara, CA (US)

(73) Assignee: APPSENSE LIMITED, Warrington (GB)

(21) Appl. No.: 13/623,658

(22) Filed: Sep. 20, 2012

(51) Int. Cl. G06F 3/01

(52) U.S. Cl. 715/744

(57) ABSTRACT

Systems, methods, and computer-readable media provide for context-sensitive, interactive logs to an administrative user console. A log server can receive at least one logging event from at least one application server based upon activity of at least one entity, identify at least one action associated with the logging event, and create and store a log entry based on the logging event and the associated action. The log server can further format an interactive display page for display at an administrative user console containing the log entry, wherein the interactive display page displays the logging event and the associated action in proximity to the logging event, and wherein the associated action can be selectable by a user at the administrative user console. In response to a selection of the associated action from the administrative user console, the associated action can be initiated.

### BACKGROUND

Administrative users currently track user activity and system activity by recording such activity using logging facilities, such as log files and log servers. Such logging facilities typically record individual event notifications, error messages, warnings and time-stamped information in a time-ordered list, generated in real time as the events occur based on user interaction or system activity. An example of a log file is a web server log, which is a text file generated by web servers such as Apache httpd (HyperText Transport Protocol Daemon), nginx, and lighttpd. As users access the web server, each user interaction, such as accessing a web page or submitting a web form, is captured as an event in the web server log. Error messages may also be generated and stored in the web server log, and an administrative user may subsequently review the log and determine a course of action. Other server applications also perform logging to a log file in substantially the same way.

A variation of logging to a log file is logging using a log server. A log server is an application that receives log messages from other applications, collects these messages into a single list, and outputs this list of log messages to a single log file or log database. A log server may handle logging for applications on the same computer, or for applications located on a network, or both. An example of a log server is syslogd (System Log Daemon), which is the standard log server for UNIX-based systems such as Linux and BSD. Syslogd receives standardized log messages from a variety of applications running on one or more computers, and saves the output to a single log file. Syslogd allows an administrative user to consolidate messages from a number of applications, to separate messages into separate log files, and to filter messages based on a priority level.

As described above, log files can be useful for an administrative user when diagnosing a problem and determining a course of action to resolve the problem. However, when faced with a long list of confusing and cryptic error messages, administrative users may find this difficult, confusing, and/or time-consuming. Also, as logs are typically stored as plain text, logs cannot provide interactive troubleshooting capability, or intelligently suggest a course of action, much less allow the user to act on the information in the log.

### SUMMARY

In accordance with the disclosed subject matter, systems, methods, and non-transitory computer-readable media provide for context-sensitive interactive logging.

In one embodiment, a log server is provided, comprising one or more interfaces configured to provide communication with at least one application server, and to provide context-sensitive, interactive logs to an administrative user console, in a communications network; and a processor, in communication with the one or more interfaces, configured to run a module stored in memory that is configured to: receive at least one logging event from the application server based upon activity of at least one entity, identify at least one action associated with the logging event, create and store a log entry based on the logging event and the associated action, format an interactive display page, for display at the administrative user console, containing the log entry, wherein the interactive display page displays the logging event and the associated action in proximity to the logging event, and wherein the associated action can be selectable by an administrative user at the administrative user console, and responsive to a selection of the associated action from the administrative user console, initiate the associated action.

The module may be further configured to: format the interactive display page, for display at the administrative user console, a plurality of log entries, wherein the plurality of log entries can be sorted based on the at least one category of data selectable by the administrative user at the administrative user console; and responsive to a selection of the at least one category of data from the administrative user console, sort the plurality of log entries for display. The module may be further configured to: format the interactive display page, for display at the administrative user console, a plurality of log entries, wherein the plurality of log entries can be filtered based on information in the at least one category of data selectable by the user at the administrative user console; and responsive to a selection of the at least one category of data from the administrative user console, filter the plurality of log entries for display.

In another embodiment, a computer-implemented method is provided, comprising a series of instructions that cause a computer to provide context-sensitive, interactive logs to an administrative user console in a communications network, the instructions including the steps of: receiving, at a log server, at least one logging event from at least one application server based upon activity of at least one entity; identifying, at the log server, at least one action associated with the logging event; creating and storing, at the log server, a log entry based on the logging event and the associated action; formatting an interactive display page for display at an administrative user console containing the log entry, wherein the interactive display page displays the logging event and the associated action in proximity to the logging event, and wherein the associated action can be selectable by an administrative user at the administrative user console; and responsive to a selection of the associated action from the administrative user console, initiating the associated action.

The instructions may further include the steps of: formatting the interactive display page, for display at the administrative user console, a plurality of log entries, wherein the plurality of log entries can be sorted based on the at least one category of data selectable by the administrative user at the administrative user console; and responsive to a selection of the at least one category of data from the administrative user console, sorting the plurality of log entries for display. The instructions may further include the steps of: formatting the interactive display page, for display at the administrative user console, a plurality of log entries, wherein the plurality of log entries can be filtered based on information in the at least one category of data selectable by the administrative user at the administrative user console; and responsive to a selection of the at least one category of data from the administrative user console, filtering the plurality of log entries for display.

In another embodiment, a non-transitory computer-readable medium is provided, the medium having executable instructions operable to, when executed by a computing device, cause the computing device to: receive at least one logging event from at least one application server based upon activity of at least one entity; identify at least one action associated with the logging event; create and store a log entry based on the logging event and the associated action; format an interactive display page for display at an administrative user console containing the log entry, wherein the interactive display page displays the logging event and the associated action in proximity to the logging event, and wherein the associated action can be selectable by an administrative user at the administrative user console; and responsive to a selection of the associated action from the administrative user console, initiate the associated action.

The executable instructions may also be operable to cause the computing device to format the interactive display page, for display at the administrative user console, a plurality of log entries, wherein the plurality of log entries can be sorted based on the at least one category of data selectable by the administrative user at the administrative user console; and responsive to a selection of the at least one category of data from the administrative user console, sort the plurality of log entries for display. The executable instructions may also be operable to cause the computing device to format the interactive display page, for display at the administrative user console, a plurality of log entries, wherein the plurality of log entries can be filtered based on information in the at least one category of data selectable by the administrative user at the administrative user console; and responsive to a selection of the at least one category of data from the administrative user console, filter the plurality of log entries for display.

In each of the above embodiments, the entity may comprise one of a user, a device, and an application. The activity may comprise one of: the at least one entity becoming unresponsive; a network link becoming unresponsive; a network resource becoming unresponsive; the at least one entity being detected as going offline at a specified time; the at least one entity causing a storage quota to be met; the at least one entity causing a storage quota to be approached; an operating system being determined to require an update to a later version; a software application being determined to require an update to a later version; a hardware sensor being activated; and a designated backup time being reached. The associated action may comprise at least one of: restarting the at least one entity; turning off the at least one entity; restarting the at least one application server; stopping the at least one application server; increasing a disk quota associated with the at least one entity; changing a network routing pattern; installing a software patch; rescheduling a reminder for a later date; alerting the at least one entity regarding a condition at the at least one application server; performing an electronic purchase; activating fire suppression measures; and initiating a backup. The log entry may include at least one category of data about the logging event comprising at least one of: timestamp, user name, application name, device name, and event description.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary network connectivity diagram of a networked system in accordance with some embodiments of the invention.

FIG. 2 is an exemplary schematic diagram of a system log view page in accordance with some embodiments of the invention.

FIG. 3 is an exemplary schematic diagram of a user profile page in accordance with some embodiments of the invention.

FIG. 4 is an exemplary flow diagram for providing context-sensitive interactive logging at a server in accordance with some embodiments of the invention.

FIG. 5 is an exemplary entity relationship diagram showing databases accessed by a log server in accordance with some embodiments of the invention.

FIG. 6 is an exemplary schematic diagram of a log server in accordance with some embodiments of the invention.

### DETAILED DESCRIPTION

Systems, methods, and non-transitory computer-readable media are provided for a context-sensitive, interactive log system. In the disclosed system, an administrative user can view relevant actions corresponding to log entries and/or error messages, and can then simply select the action to be performed. Actions can be tailored to solve the problems underlying the log entries or error messages, and can provide interactivity by allowing the administrative user to act on the information in the log, not merely by displaying the information to the administrative user. Additionally, user-specific information can be collected, shown and interacted with as a timeline of user-specific events.

While administrative consoles for computer systems have existed in the prior art, the present application discloses an interactive log that provides an administrative user with the controls typically found in an administrative console in the immediate context of a user activity log. This enables the administrative user to quickly and easily resolve administrative issues that relate to user error messages and user activity. As well, while administrative consoles have previously provided many capabilities for administrative users, the present application brings a wide range of functionality together in a single location that allows the administrative user to perform a wide range of functions without locating the functions using a traditional administrative console.

A new logging system is disclosed that can provide interactivity, as well as targeted information, to administrative users. While logging systems as known in the prior art have provided useful and actionable information, they have heretofore been limited to visualization and analysis. Providing interactive logs allows an administrative user to quickly identify administrative tasks and to perform them immediately, without the difficulty of reviewing a log, reading documentation for each error message, and accessing the relevant administrative control functionality to address the underlying problem.

The disclosed logging system allows information to be sorted and ordered by one or more data categories, such as timestamp, application, user, server, source network, target network, originating device, or any other suitable data categories or combination of data categories. Sorting may be performed in alphabetical order, time order, reverse alphabetical order, reverse time order, or any other suitable order or combination of orders. While logs may be displayed by default in time order, e.g., chronologically, an administrative user may choose to sort by the above data categories in order to quickly navigate to a particular application, user or device.

The disclosed logging system also allows filtering based on the above data categories. When an administrative user chooses to view only log entries that match a specified filter, all entries that do not match the filter can be hidden. This allows for simple viewing of logs that pertain only to a specific user, for example, or a particular server or device. Viewing a filtered log by user thus allows an administrative user to track the activity of a user. Similarly, viewing a filtered log by device or by server can allow an administrative user to determine whether the device or server has been malfunctioning repeatedly or whether a particular error is an exceptional case. Filtering can be implemented using a web-based interface, a mobile device interface, or another interface that allows for users' names and other data values to be clicked, actuated or selected. Similarly, sorting can be implemented using a web-based, mobile device or other interface that allows for data categories to be selected.

Further, the disclosed logging system allows for actions to be associated with log entries in a context-sensitive manner. Instead of merely allowing a user to view information about the world, actions provide meaningful interactivity by allowing an administrator to perform tasks and solve problems that are related to one or more log entries. An administrative user often reviews a log in order to determine which systems are not functioning normally and which users need assistance to regain access to one or more systems. However, there is a gap between identifying problems in the log and actually solving the problems. The disclosed logging system aims to narrow this gap, in some embodiments, by providing a button that serves to solve the problem corresponding to the log entries showing the problem. An administrative user may simply select the action button to perform the needed tasks without switching to another administrative tool.

In this disclosure, the term “user” is used to indicate a user of an organization's computing system (e.g., employee) and the term “administrative user” is used to indicate a user with responsibility for administering the organization's computing system. While in some cases an administrative user can be a regular user of the computing system, in a preferred embodiment the disclosed logging system is intended for use primarily by an administrative user and not by a regular user. The disclosed logging system is equipped with actions to administer the organization's computing system, which may require administrative privileges on the system and may therefore only be accessible to the administrative user and not to the regular user.

A wide variety of actions can be associated with one or more log entries. For example, the actions can include increasing a user's disk quota; rerouting network traffic away from an overheating server; purchasing additional server capacity from a cloud provider; purchasing physical hard disks from an Internet merchant such as Amazon.com; delaying a scheduled software update; causing a user to be logged out; causing a user to change his or her password on next login; activating a load balancer or other device; activating security measures in a secured data center; activating fire suppression measures in a secured data center; restarting a server or application; or any other suitable action or combination of actions. Different log entries may have different actions and/or share common actions. Different users and/or servers/devices may have the same or different actions associated with the same log entries. A log entry can have one action or more than one action associated with it. A combination of log entries associated with a user and/or server/device may trigger certain actions (e.g., a predetermined number of occurrences of the same error condition/log entry for a particular user and/or server/device may trigger certain actions). A user can select to perform one, all, or a subset of the available actions.

Selecting the action button may cause various messages to be sent or procedures to be called, based on the specific nature of the action. The action is preferably one that may be controlled using a networked computer, such as any action that can be performed over a network, over the Internet, over an intranet, over a virtual private network (VPN), or using Internet Protocol (IP) networking Two-way communication between the log server and the target of the administrative actions could also be provided by the system. Any network technology, such as HyperText Transport Protocol (HTTP), web services, representational state transfer (REST), sockets, eXtensible Markup Language (XML), JavaScript Object Notation (JSON), or another network technology could be used for communication between the administrative user and the log server, from the log server to the target server (i.e. the server receiving and executing the action), and from the target server to the log server. The log server may itself log the results of its own administrative actions.

An action may be associated with a particular log entry or a group of log entries. The group of log entries may or may not be consecutive, and as the disclosed invention supports changing the sort order of log entries, the action may be made available for just one or for all of the associated actions. The log entries provide context for the actions, so that the actions are appropriate and context-sensitive. The appropriateness of the actions may be based on identification by the log server of a potential cause for the log entry. For example, if the log entry reflects that a user is having difficulty logging in, the log server may identify that the cause may be an incorrectly-entered password, and may determine that an appropriate action would be to enable the administrator to reset the password. Resetting the password becomes a simple matter of the administrative user selecting the action button. Once the action button is selected, the underlying problem that was the cause of the log entry is addressed, thereby enabling the administrative user to effectively and efficiently administer the users, devices, and applications in the enterprise network. While the preferred embodiment is allowing the administrative user to select the action button, in some embodiments, the actions can be automatically performed in response to the server detecting particular log entries, where the particular log entries match rules that are preset by the administrative user, preprogrammed by the manufacturer, or created by a machine learning algorithm by a program executing at the server.

In some embodiments, actions are associated based on custom configuration of the log server by the administrative user. The administrative user may be able to explicitly specify a command, a script, a grammar, a regular expression, or other executable set of instructions to be linked with a particular log entry or set of entries. The administrative user may be able to use regular expressions to specify a set of entries. In some embodiments, the administrative user may be able to record actions for subsequent playback and association with one or more log entries. In some embodiments, the log server may automatically learn which log entries should be associated with which actions by automatically recording administrative actions taken by the administrative user. In other embodiments, the log server may be preprogrammed, e.g., by its manufacturer to support a particular set of actions, some of which may be customizable. Some actions may be provided by default for a particular enterprise network configuration or network purpose. For example, for a company with multiple servers used for production and development of a web site, a “web developer” set of actions may be provided, including actions such as “restart web server” and “push files from development server to production server,” whereas for a system providing automated remote physical security for one or more households, a “physical security” set of actions could be provided, including “call police” and “activate fire suppression fixtures.”

The set of potential actions may include actions to provide or deny access to a system over a network; to provide or deny physical access to a physical system (i.e., by controlling a physical security system); to provide fire or disaster suppression; to provide backup, replication or snapshot capability; to provide commonly-requested user administration tasks (e.g., resetting locked passwords); to provide common device administration tasks such as imaging or wiping devices, upgrading operating system software or application software; to provide network health and status information for devices on the public Internet or within the enterprise network; or other actions. Applications may be modified to support these actions. For example, a file server may be modified to support an action that increases a disk quota for a user, or a web server may be modified to support an action that grants permission to read a file.

After one or more log entries is associated with an action, the action may be presented together with the one or more log entries to the administrative user. In some embodiments, once the log entries are presented to the user, the log entries may be passed to another logging system, or may be output to a file or database. In other embodiments, the association is stored in a storage system, such as a database, and the stored association is used to provide the log entry and each of its associated actions when the administrative user chooses to retrieve the log entry at a later date. There may be one action, more than one action, or no actions associated with a given log entry. The actions may be triggered by buttons, touch screen entry, mouse clicks, voice input, keyboard input, or other input. In some embodiments, a button may be shown next to one or more log entries; in other embodiments, hyperlinks, touch-sensitive areas, auditory commands, gestural commands, and other commands may be made available. In the case that more than one action corresponds to a log entry, a pop-up menu or multiple selection menu may be used in place of a button. The log entries themselves may be enhanced with hypertext, such as hyperlinks, which may allow the administrative user to access detailed information about one or more entities (e.g., users, devices, servers, or applications).

While most useful in an enterprise context, when a large organization's computing resources are managed by one or more dedicated administrative users, the disclosed logging system also affords advantages to administrators of other organizations, such as sole proprietorships where a single user is responsible for administration of all systems used by that same user. Being able to quickly perform administrative tasks without requiring knowledge of how to perform the administrative tasks using the typical administrative interface is valuable for not only the expert but also the novice administrative user.

An administrative user may look up logs on a per-user, per-device, or per-server basis, or any suitable combination thereof. The disclosed logging system can be accessible via a web page, such that the logging system provides access to log entries and actions through a web application and uses hypertext markup language (HTML) to output logs to a web browser running on an administrative user's desktop computer, laptop computer, cellular telephone such as a smartphone, tablet computer, or other device. Alternatively, a native application may be used on any of the above devices, and data may be exchanged between the logging system and the native application using an encoded format such as JavaScript Object Notation (JSON). The logging system may be available via an organizational intranet, or via a virtual private network (VPN) that allows access to the organization's intranet from the public Internet, or via an extranet that allows access when the administrative user provides a password or other authentication credential. Alternatively, the disclosed logging system can provide access to the logs via a command line, such as a UNIX shell prompt, but the features of the disclosed system are intended to be used as a web application and/or through a web browser or native application. When using command-line access, certain features may not be available, such as clickable buttons. However, log entries may be provided in association with actions, and the administrative user may be presented with the option to initiate one or more actions by entering commands from the command line, e.g., using a keyboard.

In some embodiments, the disclosed logging system is capable of retrieving logs for entities, where entities can include users, devices, servers, and applications. Each of these entities may be represented in one or more databases and/or database tables. Each entity may also have additional associated information; for example, a user entity may have associated information that includes a name and contact information. The logging system may be able to initiate actions on entities, such as to enable or disable access for a user based on their user ID. The logging system may also be able to show detailed information on entities, based on information available in the relevant database and/or information that is available elsewhere on the intranet, or the public Internet. The logging system may combine information from multiple sources to create profile information on entities. Any other suitable entities, such as application profiles, lightweight directory application profile (LDAP) profiles, and corporate sub-networks, or combination of entities, may also be maintained in the logging system as entities and may also be maintained in individual databases or database tables.

In some embodiments, the disclosed logging system is also able to collate or collect information pertaining to a particular entity over time. For example, events for a particular user may be tracked over time by associating the user's entry in the user entity database with one or more log entries that are generated based on the user's activity at different times. Once a series of log entries for a particular entity is stored in the logging system, a “timeline” of these log entries may be presented via a web page to an administrative user, showing a list of log entries filtered to show only log entries for the specific user, thereby providing a simple view for collecting and displaying information about a user. The timeline may be a table view of the data listed in time order, or it may be a table view that is sorted by one or more columns, depending on what data is shown. The timeline may also have one or more controls that allow the administrative user to move backwards and forwards in time, such as buttons, scroll arrows, key shortcuts, and expanding/collapsing areas that expand to show more information about a specific time period (e.g. a year) and collapse to hide the information for navigation among the remaining displayed information. Actions may also be presented on the timeline or on the profile page. The actions may include administrative actions such as: logging out a user; resetting a user's password; alerting a user via email of a warning message; updating a user's stored information, such as contact information; or deleting a user. These actions may be presented as buttons, hyperlinks, or any other suitable format.

In some embodiments, an administrative user may access a timeline as part of a web page accessible via the log server. The timeline page can include hyperlinks, images, JavaScript, Java applets, rich media content such as video or audio, links to or embedding of external media, or any other suitable content or combination of content. The web page may be shown on a desktop operating system, such as Windows, Mac OS X, or Linux, or on a mobile operating system on a mobile device in a mobile web browser, such as on Safari on an iPhone or Google Chrome on an Android device. Alternately, a native application may be provided to show the timeline and profile pages. Hyperlinks may allow the administrative user to link to other data that may not be shown on the user profile page. For example, if a log entry describes a particular user as being connected to a server, and the server is hyperlinked, the hyperlink can allow for filtering the log to find more content relating to the user and the server, or can redirect the administrative user to a web page that shows only information pertaining to the server and to other users. Hyperlinks may be used in this manner to filter on, or show profile pages of, any entity that is described herein, such as a server, device, user, and application. Buttons may also be located next to log entries as well, allowing the administrative user to perform context-specific actions as described below.

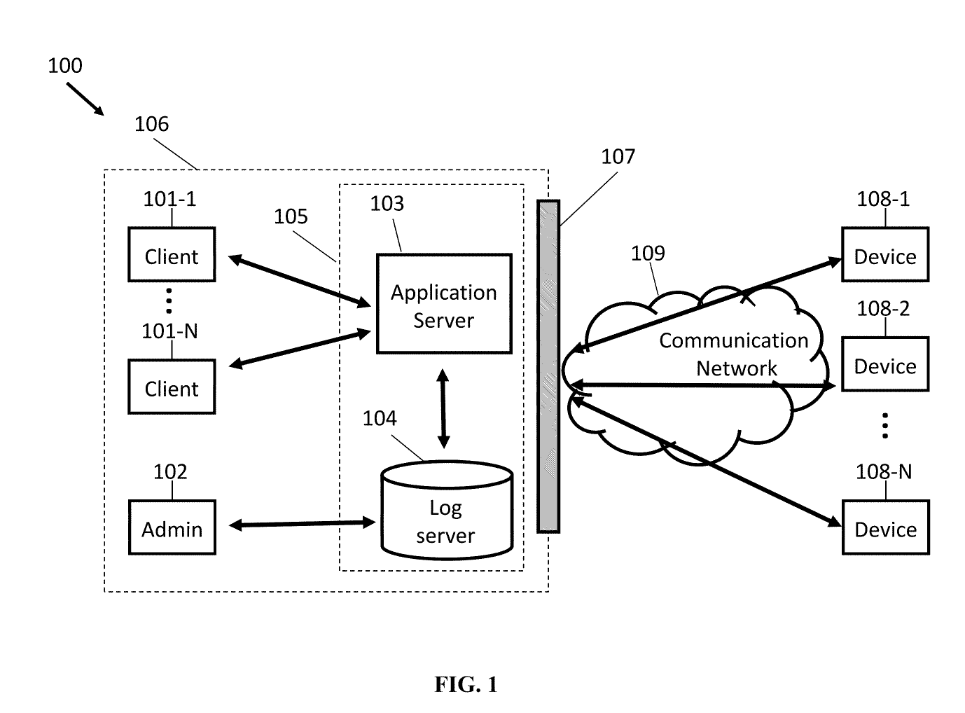

FIG. 1 is an exemplary network connectivity diagram of a networked system. Network connectivity diagram 100 includes network 106, which includes clients 101-1 . . . 101-N, administrative client 102, application server 103, and log server 104. Network 106 may be an enterprise network or corporate network. The network may include one or more clients, such as clients 101-1 . . . 101-N. The clients may be user workstations, smartphones, laptops, desktops, and tablets. The clients may also be servers, security systems, appliances, switches, routers or other network infrastructure, or other devices. The clients may be used by individual users on the network, or may be servers that provide services to other clients on the network. These clients may be in communication with application server 103, which in turn is in communication with log server 104.

Application server 103 is an exemplary server that provides services to users and outputs logging messages. Examples of application servers can include: web servers such as Apache httpd, lighttpd, nginx; proxy servers such as squid; domain name system (DNS) servers; web application servers such as Apache Tomcat; file servers providing networked file storage, including Linux file servers, NetApp and EMC storage appliances, and file transfer protocol (FTP)/secure file transfer protocol (SFTP) servers; mail servers, such as post office protocol (POP), Internet mail application protocol (IMAP), simple mail transport protocol (SMTP), or Microsoft Exchange-based mail servers; database servers, such as Oracle servers; directory servers, such as lightweight directory access protocol (LDAP) and Microsoft Active Directory servers; remote login servers such as secure shell (SSH), virtual network computing (VNC), and Microsoft Remote Desktop; and other servers that are typically used in an intranet, enterprise, or organizational environment. In a typical environment, a single log server may support a plurality of application servers.

Each of these servers currently provides logging functionality. In some embodiments, the built-in logging functionality of these servers can be used to output log information to a file, which is then sent to log server 104. In other embodiments, a UNIX named pipe (commonly known as a “FIFO”) may be used to send data to log server 104 without saving the data to a file. In other embodiments, the built-in logging functionality of these servers may be turned off. In other embodiments, built-in logging may be used in conjunction with a separate log being sent to log server 104. In other embodiments, the application server 103 may be modified to support some or all of the features of log server 104.

In some embodiments, application server 103 and log server 104 may be physically separate servers, or may be found contained within a single device, as is represented by dotted line 105, or in different devices. In some embodiments, application server 103 and log server 104 may be integrated into a single server or may operate concurrently on a single server. In some embodiments, there may be multiple application servers communicating with a single log server. In some embodiments, multiple log servers may communicate with one or more application servers.

An administrative user may use an administrative device 102 to contact log server 104 to view logs and initiate actions. Actions are described in further detail below. Administrative device 102 may be a user workstation, smartphone, laptop, desktop, tablet, server, or other network-enabled device. Administrative device 102 may use a web browser, an application using HyperText Transport Protocol (HTTP), a touch-enabled application, a mobile application, a smartphone application, or another application to access log server 104. A firewall 107 may be present in some embodiments, where a firewall is a network device that separates network 106 from the public Internet. Firewall 107 may provide security features, access control, authentication, spam protection, port blocking/port mapping, address mapping, active intrusion detection, and/or other features for the enterprise network. Communications network 109, which may be the public Internet, a service provider's network or another network, is present on the outside of firewall 107, and is a medium for communication with one or more remote devices 108-1, 108-2, . . . 108-N. Devices 108 may be any of the types described above with reference to clients 101 (e.g., user workstations, smartphones, laptops, desktops, tablets, servers, security systems, appliances, switches, routers or other network infrastructure, or other devices).

These devices can be in communication with one or more of application server 103, log server 104, or other servers within the network via firewall 107. For example, a device 108-1 outside the firewall may access a file server within the firewall. The file server may be one instance of application server 103, and may provide a log to log server 104, which is thus enabled to track activity by a user when using device 108-1.

In this exemplary network diagram, when the user of a client device (e.g., device 101-1) accesses application server 103, a log entry is created based on user activity and stored in log server 104. For example, a user may access a file server to retrieve a file. In this example, the file server corresponds to application server 103. The request to retrieve a file may be logged, e.g., may cause a message to be created reflecting the activity. Log information may typically include the date and time of the activity; the type of activity (e.g., requesting a file); any information relevant to the activity (e.g., the file that is requested); and a result code (e.g., “access granted”). The message may be sent to log server 104 and stored.

In some embodiments, log server 104 may include a log file or database for providing basic logging functionality for an application. These log entries may then be parsed by log server 104 and associated with one or more entities in some embodiments, where entities can be users, devices, applications, or actions. The entity associated with the log entries may then be used to build one or more webpages, timelines, or other forms of data visualization, with varying degrees of interactivity, in some embodiments. In other embodiments, log server 104 may receive logging information directly from applications, e.g., without reading a log file or database. In such embodiments, log server 104 may optionally create a log file or use a log database, for example, to provide support for legacy applications such as log analyzers or to allow an administrative user to view log files manually.

In some embodiments, log server 104 may enable actions to be performed by the administrative user. As described previously, context-specific actions may be associated with log entries. The log server may determine what actions to provide in association with a given set of log entries, and may handle communication from the administrative user indicating that the actions should be performed. Log server 104 may take advantage of connectivity with other parts of the enterprise network to perform actions. For example, increasing a disk quota for a particular user may be an action, enabled by log server 104, that results in a request from log server 104 to a file server on the enterprise network (not shown) to increase the quota of the particular user. When making a request to a protected system on the enterprise network or on any network, the log server may use stored authentication credentials or may require the administrative user to log into the protected system. In the case of the file server action, the file server may request log server 104 to provide authentication before increasing the quota of the user. Log server 104 may respond with the cached or pre-stored authentication information of the administrative user to authorize the operation.

Specific displays of logs may be generated on-the-fly from log content, or they may be generated when log content is received, upon request by an administrative user, or at another suitable time, condition, and/or combination thereof. Logs may be displayed in webpages, e.g., by providing a web interface to the log data using a web application server connected to the log server. Log displays may also take the form of timelines, which are specifically ordered by time and which permit a user to review log entries over time. Logs may be displayed via mobile devices or mobile applications, or on desktop or laptop computers, or via other forms of log display. An administrative user may use administrative device 102 to access logs. Logs may contain records of user activity, server activity, application activity, administrative user activity, administrative user action, or other activity.

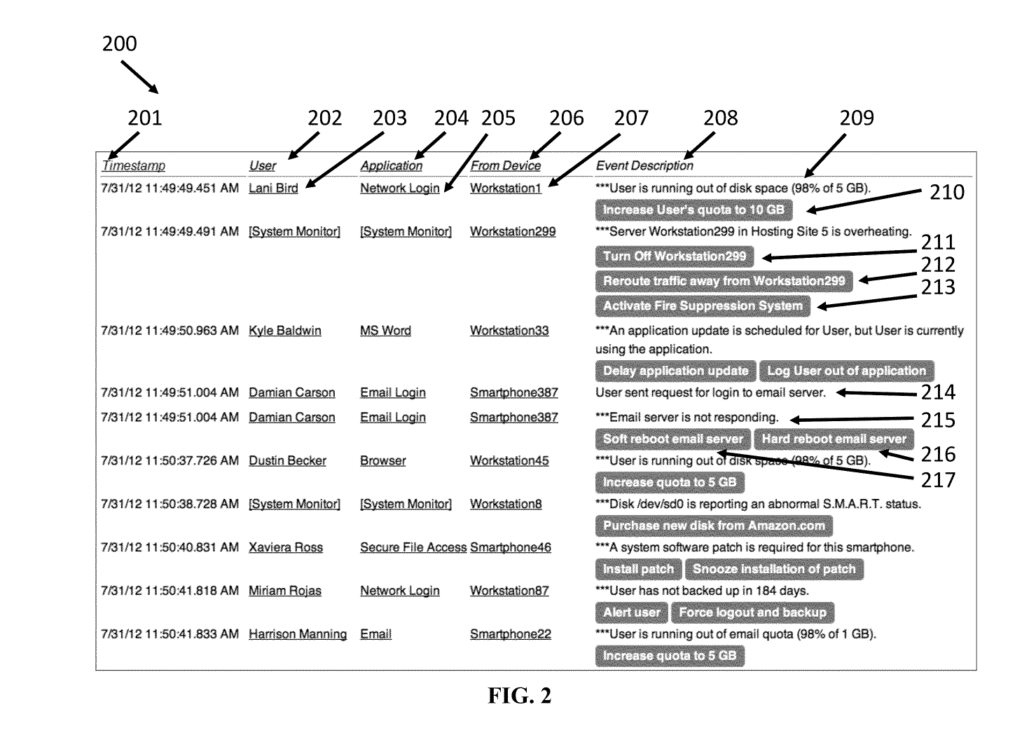

FIG. 2 is an exemplary schematic diagram of a system log view page. Log view 200 includes data categories such as timestamp 201, user name 202, application name 204, device name 206, event description 208, or any other suitable data category or combination of data categories. Each row is a log entry, and the log entry is generated when a given event takes place, e.g., when a user saves a file, or when a user logs into a system. Each data category may be presented as a numeric ID, or as a user-friendly name. User-friendly names may include the name of a user for the user category. For other categories, user-friendly names may include, e.g., a name of an application or the full pathname of the application for the application category; a short device name such as “Workstation299” for a device; and other user-friendly names for other categories. Each data category header can be presented as a hyperlink, clickable area, touch-sensitive area, or button, so that an administrative user may interact with the data by sorting it by data category. Thus, while the view may be presented as shown in FIG. 2 in a time order by default, the display may be reconfigured to provide a user grouping order (e.g., by selecting user heading 202, which may be a hyperlink), an application grouping order (e.g., by selecting application heading 204, which may be a hyperlink), by device grouping order (e.g., by selecting device heading 206, which may be a hyperlink), by event description order (e.g., by selecting event description heading 209), or other order. This differs from the traditional approach, which provides the log in only time order; the invention allows for the log to be provided in any suitable order. For example, as shown in FIG. 2, the log may be provided in time order. In other embodiments, the log may be grouped by user, application, device, event description, or any other suitable data category. In other embodiments, the log may be grouped by more than one data category. For example, the log may be first grouped by user and within each user grouped by application, device, and/or event description. Any suitable grouping of data categories and order of grouping of data categories can be used.

An administrative user can select data categories for sorting by selecting the heading (e.g., timestamp heading 201, user heading 202, application heading 204, device heading 206, and description heading 208). Selecting a data category heading that is being used as the current sort criterion may cause the sort order for the current log display to be reversed. The administrative user may use a secondary click or right-click on a heading to bring up a pop-up menu that is located over the heading and that may include options for filtering to filter the log display to include only log entries that match a certain value in a certain category, or that do not match a certain value. The log display may refresh in real time, or may be presented as a time-delayed view, or may be presented as a static view that requires the administrative user to explicitly refresh the view. Configurable default settings for sorting and filtering may be provided in some embodiments, and in other embodiments the logging system may automatically determine the administrative user's settings or may restore the last-used settings. Only an administrative user can access any logging information, in some embodiments. In certain embodiments, only an administrative user may see actions or perform actions, as the actions rely on the administrative user's authentication credentials with other systems on the network, as described above.

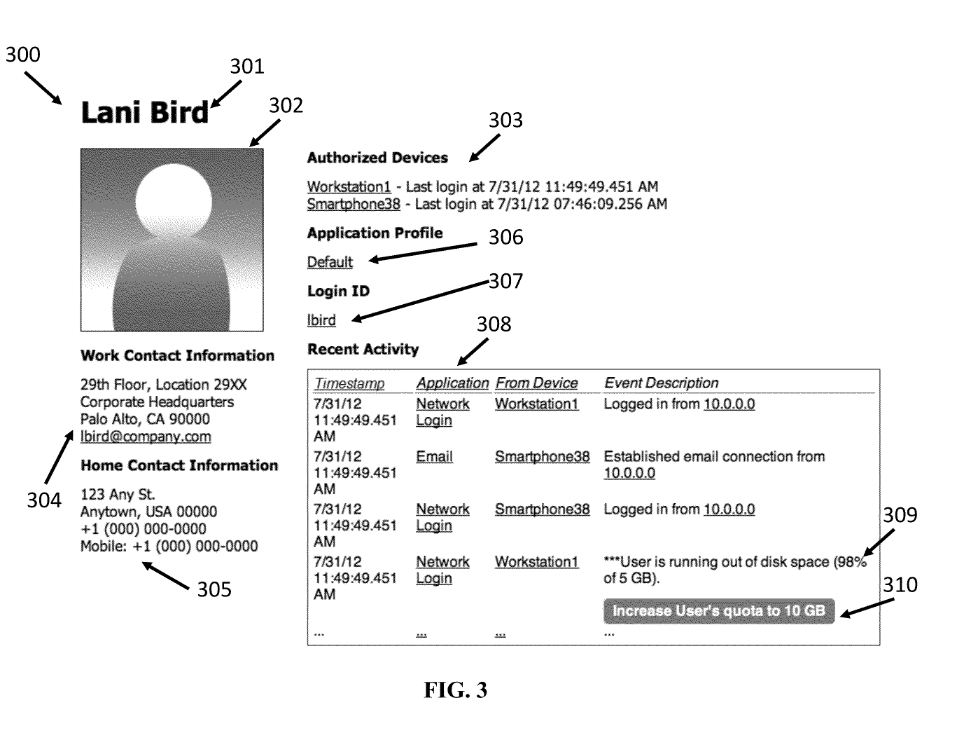

In some embodiments, specific data values can be hyperlinked. In some embodiments, clicking on a data value can filter the log display to show only log entries that match the specified data value. In some embodiments, clicking on other data values can cause the log display to be replaced with a new display, such as a “user profile page” showing details about a user, or a “server status page” showing status and log entries for a given server, or a “device status page” showing status and log entries for a given device. Based on whether categories are used for linking to a new display or for filtering, some categories can have some or all values hyperlinked (e.g., user names may be linked to user profiles), while other categories may have no values hyperlinked (e.g., timestamps tend to be unique or nearly-unique, so neither showing a “profile page” nor filtering the log display based on these unique values tends not to be useful). For example, the user “Lani Bird” 203 is hyperlinked, as is application “network login” 205, “workstation1” 207. In one embodiment, the user Lani Bird can have a profile page as shown in FIG. 3. The device Workstation1 207 may have a similar profile page showing further information about the device that may be useful to the administrative user. On the other hand, the application “network login” 205 may not have a profile page so that a click on the data value may instead result in filtering the current log view to display only log entries that match the data value “network login.” Different embodiments may provide different combinations of profile pages, hyperlinks, sorting and filtering functionality.

In some embodiments, context-specific actions can be presented to the administrative user as selectable buttons located adjacent to the log entry that provides the relevant context. For example, button 210, “Increase User's quota to 10 GB,” is a context-specific action that is relevant to the logged event “User is running out of disk space (98% of 5 GB).” If a given user is running out of disk space, and the administrative user has the proper authority, the administrative user can resolve the potential issue of the user running out of disk space by increasing the amount of disk space allotted to the user (e.g., the user's disk space quota). The administrative user may perform this action by selecting button 210. The logging system receives the administrative user's selection and initiates the action. If additional credentials are needed to perform the action, such as via communication with an intranet file server, as shown here, the logging system may use the administrative user's stored credentials or may prompt the administrative user for credentials at the time of the click. The administrative user is thus given the opportunity to interact with the log to resolve problems and perform administrative tasks without being removed from the context of the log display page.

As described above, the specific actions may be pre-programmed into the log server, or may be configured by one or more administrative users, or may be learned from actions taken by one or more administrative users. More than one action may be provided for a given log entry, as shown by buttons 211, 212, 213. Button 211 describes the action “Turn Off Workstation299,” button 212 describes the action “Reroute traffic away from Workstation299,” and button 213 describes the action “Activate Fire Suppression System.” In the case of buttons 211-213 and in this specific embodiment, three actions are appropriate given the log entry “Server Workstation299 in Hosting Site 5 is overheating.” The administrative user is given the choice of performing one or more of these actions. In certain embodiments, an administrative user may be able to configure the order and number of actions that are presented to the administrative user viewing the log.

In some cases no actions are appropriate for a log entry. For example, log entry 214, “User sent request for login to email server,” has no appropriate action next to it. In other cases, an action may be associated with more than one log entry. The action may be displayed next to each of the log entries or alternatively may be displayed next to only one log entry. For example, multiple warnings may be followed by a final warning, and only the final warning may have an associated action displayed (not shown). In other cases, more than one action may be associated with one log entry. For example, log entry 215, “Email server is not responding,” is followed by two actions 216 (“Hard reboot email server”) and 217 (“Soft reboot email server”), where both log entry 214 and 215 provide context for the two actions (i.e. indicating that activity is occurring at the email server and indicating that the email server is having a problem).

FIG. 2 also shows a number of other actions that can be performed for an administrative server, such as: delaying application update or logging a user out of an application when a user is using an application scheduled to be updated; purchase a new disk from Amazon.com (or other source) as a replacement for a disk that is reporting an abnormal status; install a system software patch; delay a system software patch; alert user of an overdue backup; and force the user to log out and back up. These actions are exemplary and provide examples of the wide variety and range of actions that may be implemented in the disclosed logging system.

FIG. 3 is an exemplary schematic diagram of a user profile page. The user profile page may be provided in response to selecting a hyperlink, or can be directly accessed by browsing/searching the corporate intranet. The user profile page can include the user's name/page title 301, picture 302, a list of authorized devices 303, work contact information 304, home contact information 305, an application profile 306, a login ID 307, and a recent activity log 308. The user profile page can include additional information, fewer information, or any other suitable information or combination of information. Information can be displayed on the user profile page in any suitable location in any suitable format.

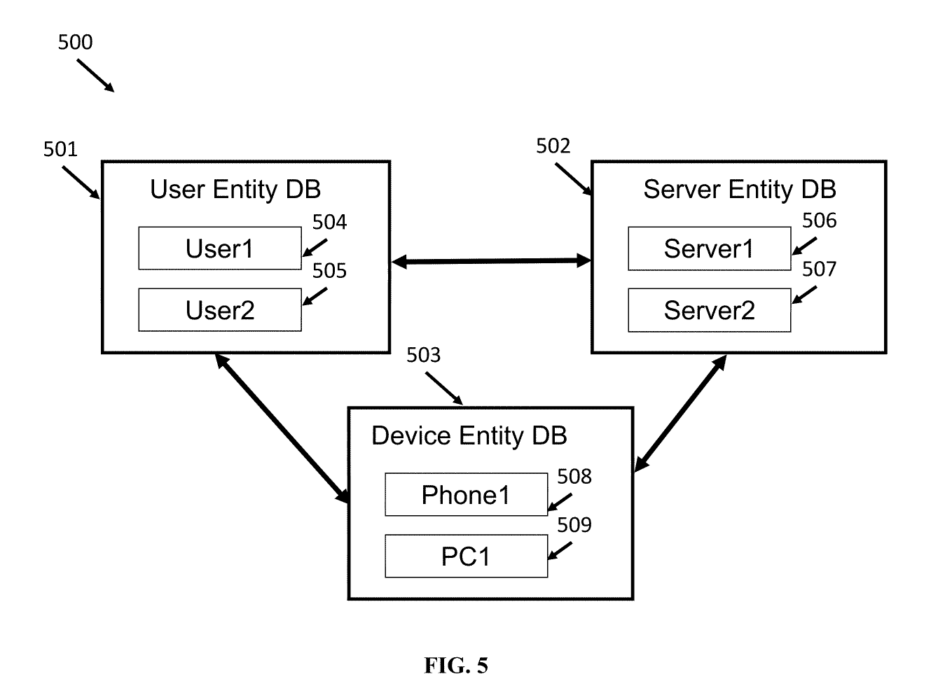

User Lani Bird is identified at page title 301 and in picture 302. Device listing 303 reflects devices that are associated with this user. In certain embodiments, entities may be associated with each other, such as, in this instance, multiple devices being associated with a single user. In this example, the Authorized Devices listing 303 shows when the user has last logged into the system and from what device. Association of entities is further described in reference to FIG. 5 below. Arbitrary information such as work contact information 304, home contact information 305, and login ID 307 may also be stored in the user entity database and provided in association with the specific user profile page.

The recent activity view 308 provides a time-ordered view of all log entries relating to this particular user. The depicted recent activity view may be considered a timeline, in certain embodiments. By extracting only log entries that have to do with this particular user, an administrator is allowed to see and track this user's activity over time. The number of entries on the user's profile page is variable and may be greater or smaller in different embodiments. While recent activity view 304 is represented similarly as in FIG. 2, alternate visualizations may also be provided in some embodiments. For example, an animated timeline or a timeline using a movable controller may be used to provide alternative navigational and informational views of the user's activity. As this information is presented in a webpage, any timeline view that may be provided in a webpage may be provided here. The recent activity view 208 does not need to be displayed in time order; indeed, it may be grouped by application, device, and/or event description as well, and may be sortable and filterable as described above in reference to FIG. 2. Action button 310 (“Increase User's quota to 10 GB”) provide context-sensitive interaction in light of log entry 309 (“User is running out of disk space (98% of 5 GB)”), also as described above in reference to FIG. 2. As button 310 is being presented on Lani Bird's profile page, it may also be context-sensitive to the selected user, in some embodiments. This may allow certain buttons to have shorter labels without sacrificing comprehensibility.

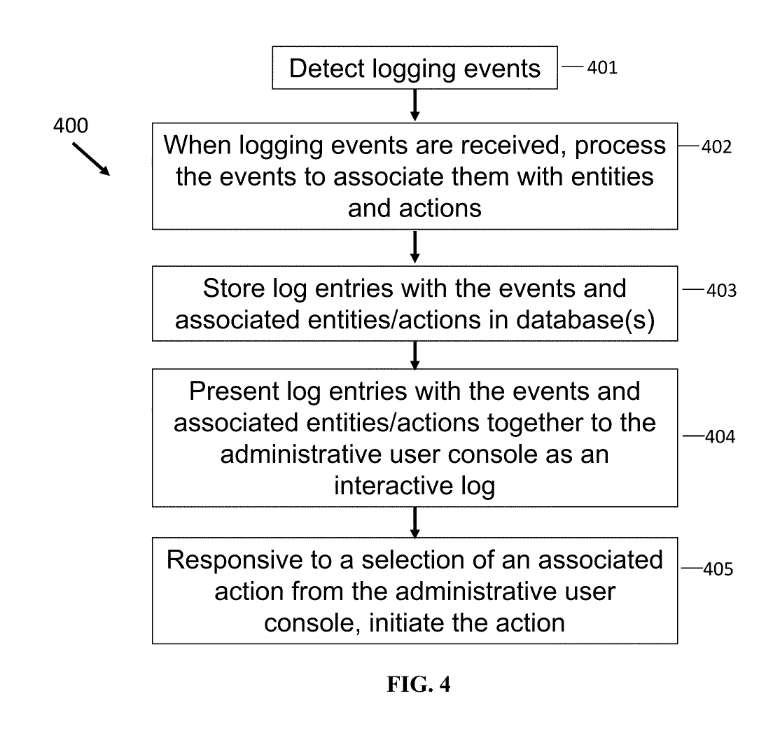

FIG. 4 is an exemplary flow diagram for providing context-sensitive interactive logging at a log server like that shown in FIG. 1. At step 401, log server 104 is in a listening state to detect logging events. At step 402, events are detected at the log server 104, e.g., from an application server 103, based on user activity. For example, a user logging into a desktop environment could cause an application server 103 to generate a logging event and send it to log server 104 as a message formatted in plain text, or according to the standard syslog protocol defined in the Internet Engineering Task Force (IETF) Request for Comments (RFC) 5424, or according to a custom format, potentially using JavaScript, JSON, or another language. The message may include at least a timestamp for the event, a hostname from which the message originates, and a message that identifies the nature of the event to be logged.

When the logging event is detected, log server 104 processes the event to associate it with any entities or actions to which it may be related. For example, the user logon event would be sent in a format containing the name of the user logging on. Log server 104 processes it to identify the user and associates the event with the user record, if the user already has an entry in the user database. Log server 104 may also identify that the logon event is related to a particular device, and will associate the event with the device. As well, log server 104 processes the event further to identify whether the event should be associated with an action. As described above, various methods may be used to identify relevant actions for events, including: using a lookup table of messages to associate certain messages with certain actions; associating messages with actions based on a regular expression for each action, where each corresponding action to a matching regular expression is associated with the message; using historical records to associate actions in log messages if a given action has previously been associated with a similar message; and other methods. In some embodiments, log entries may be considered to be created at this step.

After the logged event has been received, normal, non-interactive logging may occur. This may occur before or after step 402. If the logged event contained a log message provided by the application, normal logging consists of saving the log message to a log file. If the logged event did not contain a log message, normal logging consists of formatting the logged event as a log message and saving it to a log file. This log file is non-interactive, and the log server 104 will not subsequently access the log file to retrieve information for display to the administrative user. The log file will remain on disk in a location configured by an administrative user and will be accessible using industry-standard log processing tools, such as grep and sed. In some embodiments, when non-interactive logging occurs prior to step 402, logged event information may be sent to the log server 104 after non-interactive logging has already occurred at application server 103. Non-interactive logging may be skipped in some embodiments.

At step 403, log server 104 creates and stores the processed log entry into one or more databases, where databases may be databases or database tables, and one database exists for each entity. In the example presented above, the processed log entry is stored in the user database in association with the particular user record, and the processed log entry is also stored in the device database in association with the particular device used for logon. Any actions are also stored with any and all entity databases. In some embodiments, an action database may exist. However, an action database is not required for interactive log operation as described herein.

At step 404, the log is ready to be presented in an interactive form to an administrative user. The administrative user can access the interactive log by requesting a global timeline (i.e., unfiltered but ordered by time), a user timeline (i.e., filtered to retrieve only log entries of a particular user), a device timeline (only for a particular device), or an application timeline (only for a particular application). If the administrative user accesses the interactive log, all log entries corresponding to the requested filters may be retrieved from the relevant database and presented to the administrative user console as described above in connection with FIGS. 2 and 3. If an administrative user accesses the interactive log without requesting a timeline, the interactive log can be filtered and presented in time order or shown in any other order as described herein. When the interactive log is presented to the administrative user console, the log entries that are presented may include log events associated with entities and/or actions. As actions appear in association with log events, actions are thus presented in context for the administrative user to perform administrative tasks related to the logged events.

At step 405, responsive to a selection of an associated action from the administrative user console, log server 104 may initiate the selected action. Log server 104 may cause the action to be initiated, or it may perform the action. Log server 104 may receive parameters from the administrative user console in connection with the action to be performed. Log server 104 may redirect the administrative user console to another server to perform the action. Log server 104 may additionally monitor the action during its performance, and may additionally send a message to the administrative user console for notifying the administrative user of the action's completion. Alternatively, completion of the action may be communicated to the administrative user via another means, such as email, voicemail, text message, or other notification means, and may be communicated by the log server or by another server.

FIG. 5 is an exemplary entity relationship diagram showing databases used by log server 104 to store log entries in association with actions. In the below disclosure, “database” is understood to mean both “database” or “database table,” as appropriate. Each of the below databases may represent and store entities that are the subject of log events and log entries according to database technologies used by databases such as Oracle, IBM DB2, Microsoft SQL Server, PostgreSQL, MySQL, SQLite, and other databases. The detailed operation of these databases is beyond the scope of this application. These databases are accessed by, e.g., log server 104. At least three databases for entities may be provided: user entity database 501, server entity database 502, and device entity database 503. As examples, in FIG. 5, user entity database 501 can include one or more users (e.g., user1 504 and user2 505) as part of a list of users; server entity database 502 can include one or more servers (e.g., server1 506 and server2 507) as part of a list of servers, and device entity database 503 can include one or more devices (e.g., phone1 508 and PC1 509) as part of a list of devices. Devices may be any devices that are known to the enterprise network (e.g., user workstations, smartphones, laptops, desktops, tablets, servers, security systems, appliances, switches, routers or other network infrastructure, or other devices). Each user in user entity database 501 may have access to one or more servers in server entity database 502, and may have access to one or more devices in device entity 503. Similarly, a server in server entity database 502 may be associated with one or more users in user entity database 501 and a server can be may be accessed by one or more devices in device entity 503; and a device in device entity database 503 may be accessed by one or more users in user entity database 501 and may be used to access one or more servers in server entity database 502. Users, servers, and devices may be located in the enterprise network, on the public Internet, or anywhere else; their location and connectivity is not relevant for their storage within the databases shown here.

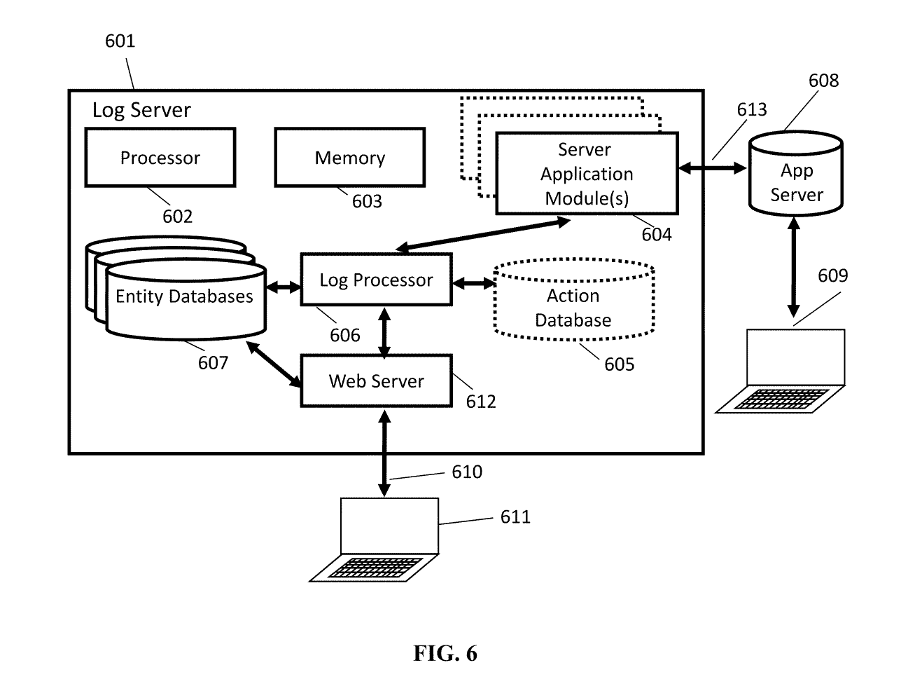

FIG. 6 is an exemplary schematic diagram of a log server. Log server 601 (showing a detail of exemplary log server 104) includes processor 602, memory 603, one or more server application modules 604, action database 605, log processor 606, entity databases 607, and administrative web server 612. Log server 601 receives logging event information from app server 608 via interface 613. Application (App) server 608 corresponds to application server 103 and may include any server providing an application available to a user, such as email servers, file servers, Web servers, virtual machine servers, content management systems, authentication servers, or other servers that create log information and store it in a log. Client device 609 (cf. user devices 101-1 . . . 101-n) may be in communication with app server 608 to obtain application services. An administrative user may can use administrative client 611 via interface 610 to access administrative web server 612. Processor 602 and memory 603 are typical components of a digital processing system and are described in greater detail below. Server application modules 604 interface with one or more app servers 608, and provide the capability for log server 601 to interface with and receive messages from one or more server applications, of which app server 608 provides one. Action database 605 and entity databases 607 provide storage of interactive log entries, and entity databases 607 correspond to FIG. 5's databases 501, 502 and 503. Log processor 606 coordinates the activity of all components in log server 601 according to the flow diagram in FIG. 4. Administrative web server 612 is for providing the interactive log as shown in FIGS. 2-3.

When log information is created by application server 608, it is provided to log server 601 via server application modules 604. Server application modules 604 may maintain ordinary logs, in some embodiments. In addition, they provide logged event information to log processor 606. Log processor 606, in turn, associates log entries with entities and actions, and stores this associated information in entity databases 607 and action database 605. The entities may include users, servers, devices, applications, or other entities, as described above. In the process of association, log processor 606 relies on retrieving entities and actions from entity databases 607 and action database 605. In some embodiments, action database 605 is not needed because log processor 606 operates with a set of actions that is internal to the log processor or part of the logic governing its operation.

In some embodiments, subsequent retrieval of log information is performed by retrieving the information from the entity databases 607 in associated form, further processing the information at log processor 606 to add HTML and other webpage information, and outputting the information via a web server. The associated actions, and controls for initiating these actions, are added at this stage, where the text on the face of the button is designed to indicate to the administrative user what action will be performed. In this figure, this Web server is co-located administrative web server 612. Different embodiments may provide different combinations of the modules described herein, while still permitting the modules to communicate with each other.

Upon receipt of the log in presentation format, the administrative user is free to review the log and also to select one or more action controls/buttons in order to initiate the actions described on the buttons. When a button is clicked, a request is sent from the administrative user console back to the log processor 606 via interface 610, and log processor 606 determines whether to communicate the action back to the application server 608 via server application module(s) 604, or whether to directly perform the action. If the action required is not directly under the control of the application server, such as the case when ordering additional storage in the form of hard disks or S3 cloud storage (e.g., from Amazon.com or other source), the application module may not send instructions to perform the action back to application server 608.

Referring further to FIG. 6, processor 602 can be configured to implement the functionality described herein using computer executable instructions stored in a temporary and/or permanent non-transitory memory. For example, the non-transitory memory can be flash memory, a magnetic disk drive, an optical drive, a programmable read-only memory (PROM), a read-only memory (ROM), or any other memory or combination of memories. The processor 602 can be a general purpose processor and/or can also be implemented using an application specific integrated circuit (ASIC), programmable logic array (PLA), field programmable gate array (FPGA), and/or any other integrated circuit.

Interfaces 610 and 613 can allow log server 601 to communicate with other systems, such as other devices on one or more networks, server devices on the same or different networks, or user devices either directly or via intermediate networks, and including app server 608 and user administrative console 611. Interfaces 610 and 613 can be implemented in hardware to send and receive signals in a variety of mediums, such as optical, copper, and wireless, and in a number of different protocols some of which may be non-transient.

Log server 601 can operate using an operating system (OS) software. In some embodiments, the OS software is based on a Linux software kernel and runs specific applications in the server such as monitoring tasks and providing protocol stacks, although other operating system can be used. The OS software can allow server resources to be allocated separately for control and data paths. For example, certain packet accelerator cards and packet services cards can be dedicated to performing routing or security control functions, while other packet accelerator cards/packet services cards can be dedicated to processing user session traffic. As network requirements change, hardware resources can be dynamically deployed to meet the requirements in some embodiments.

The software in log server 601 can be divided into a series of tasks that perform specific functions. These tasks can communicate with each other as desired to share control and data information throughout log server 601. A task can be a software process that performs a specific function related to system control or session processing. Three types of tasks can operate within log server 601 in some embodiments: critical tasks, controller tasks, and manager tasks. The critical tasks can control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem (as described below), and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem can be a software element that either performs a specific task or is a culmination of multiple other tasks. A single subsystem includes critical tasks, controller tasks, and manager tasks. Some of the subsystems that run on log server 601 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem can work in conjunction with the recovery control task subsystem to maintain the operational state of log server 601 by monitoring the various software and hardware components of log server 601. Recovery control task subsystem can be responsible for executing a recovery action for failures that occur in log server 601 and receives recovery actions from the high availability task subsystem. Processing tasks can be distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will preferably not be affected by that problem.

A shared configuration task subsystem can provide the log server 601 with an ability to set, retrieve, and receive notification of server configuration parameter changes and is responsible for storing configuration data for the applications running within the log server 601. A resource management subsystem can be responsible for assigning resources (e.g., processor and memory capabilities) to tasks and for monitoring the task's use of the resources.

In some embodiments, log server 601 can reside in a data center and form a node in a cloud computing infrastructure. Log server 601 can also provide services on demand such as Kerberos authentication, HTTP session establishment and other web services, and other services. A module hosting a client can be capable of migrating from one server to another server seamlessly, without causing program faults or system breakdown. A log server 601 in the cloud can be managed using a management system.

Other embodiments are within the scope and spirit of the invention(s).

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A log server comprising:
one or more interfaces configured to provide communication with at least one application server, and to provide context-sensitive, interactive logs to an administrative user console, in a communications network; and
a processor, in communication with the one or more interfaces, configured to run a module stored in memory that is configured to:
receive at least one logging event from the application server based upon activity of at least one entity,
identify at least one action associated with the logging event,
create and store a log entry based on the logging event and the associated action,
format an interactive display page, for display at the administrative user console, containing the log entry, wherein the interactive display page displays the logging event and the associated action in proximity to the logging event, and wherein the associated action can be selectable by an administrative user at the administrative user console, and
responsive to a selection of the associated action from the administrative user console, initiate the associated action.

2. The log server of claim 1, wherein the activity comprises one of: the at least one entity becoming unresponsive; a network link becoming unresponsive; a network resource becoming unresponsive; the at least one entity being detected as going offline at a specified time; the at least one entity causing a storage quota to be met; the at least one entity causing a storage quota to be approached; an operating system being determined to require an update to a later version; a software application being determined to require an update to a later version; a hardware sensor being activated; and a designated backup time being reached.

3. The log server of claim 1, wherein the associated action comprises at least one of: restarting the at least one entity; turning off the at least one entity; restarting the at least one application server; stopping the at least one application server; increasing a disk quota associated with the at least one entity; changing a network routing pattern; installing a software patch; rescheduling a reminder for a later date; alerting the at least one entity regarding a condition at the at least one application server; performing an electronic purchase; activating fire suppression measures; and initiating a backup.

4. The log server of claim 1, wherein the log entry includes at least one category of data about the logging event comprising at least one of: timestamp, user name, application name, device name, and event description.

5. The log server of claim 4, wherein the module is further configured to:
format the interactive display page, for display at the administrative user console, a plurality of log entries, wherein the plurality of log entries can be sorted based on the at least one category of data selectable by the administrative user at the administrative user console; and
responsive to a selection of the at least one category of data from the administrative user console, sort the plurality of log entries for display.

6. The log server of claim 4, wherein the module is further configured to:
format the interactive display page, for display at the administrative user console, a plurality of log entries, wherein the plurality of log entries can be filtered based on information in the at least one category of data selectable by the user at the administrative user console; and
responsive to a selection of the at least one category of data from the administrative user console, filter the plurality of log entries for display.

7. The log server of claim 1, wherein the entity comprises one of a user, a device, and an application.

8. A computer-implemented method comprised of a series of instructions that cause a computer to provide context-sensitive, interactive logs to an administrative user console in a communications network, the instructions including the steps of:
receiving, at a log server, at least one logging event from at least one application server based upon activity of at least one entity;
identifying, at the log server, at least one action associated with the logging event;
creating and storing, at the log server, a log entry based on the logging event and the associated action;
formatting an interactive display page for display at an administrative user console containing the log entry, wherein the interactive display page displays the logging event and the associated action in proximity to the logging event, and wherein the associated action can be selectable by an administrative user at the administrative user console; and
responsive to a selection of the associated action from the administrative user console, initiating the associated action.

9. The computer-implemented method of claim 8, wherein the activity comprises one of: the at least one entity becoming unresponsive; a network link becoming unresponsive; a network resource becoming unresponsive; the at least one entity being detected as going offline at a specified time; the at least one entity causing a storage quota to be met; the at least one entity causing a storage quota to be approached; an operating system being determined to require an update to a later version; a software application being determined to require an update to a later version; a hardware sensor being activated; and a designated backup time being reached.

10. The computer-implemented method of claim 8, wherein the associated action comprises at least one of: restarting the at least one entity; turning off the at least one entity; restarting the at least one application server; stopping the at least one application server; increasing a disk quota for the at least one entity; changing a network routing pattern; installing a software patch; rescheduling a reminder for a later date; alerting the at least one entity regarding a condition at the application server; performing an electronic purchase; activating fire suppression measures; and initiating a backup.

11. The computer-implemented method of claim 8, wherein the log entry includes at least one category of data about the logging event comprising at least one of: timestamp, user name, application name, device name, and event description.

12. The computer-implemented method of claim 11, wherein the instructions further include the steps of:
formatting the interactive display page, for display at the administrative user console, a plurality of log entries, wherein the plurality of log entries can be sorted based on the at least one category of data selectable by the administrative user at the administrative user console; and
responsive to a selection of the at least one category of data from the administrative user console, sorting the plurality of log entries for display.

13. The computer-implemented method of claim 11, wherein the instructions further include the steps of:
formatting the interactive display page, for display at the administrative user console, a plurality of log entries, wherein the plurality of log entries can be filtered based on information in the at least one category of data selectable by the administrative user at the administrative user console; and
responsive to a selection of the at least one category of data from the administrative user console, filtering the plurality of log entries for display.

14. The computer-implemented method of claim 8, wherein the entity comprises one of a user, a device, and an application.

15. A non-transitory computer-readable medium having executable instructions operable to, when executed by a computing device, cause the computing device to:
receive at least one logging event from at least one application server based upon activity of at least one entity;
identify at least one action associated with the logging event;
create and store a log entry based on the logging event and the associated action;
format an interactive display page for display at an administrative user console containing the log entry, wherein the interactive display page displays the logging event and the associated action in proximity to the logging event, and wherein the associated action can be selectable by an administrative user at the administrative user console; and
responsive to a selection of the associated action from the administrative user console, initiate the associated action.

16. The non-transitory computer-readable medium of claim 15, wherein the activity comprises one of: the at least one entity becoming unresponsive; a network link becoming unresponsive; a network resource becoming unresponsive; the at least one entity being detected as going offline at a specified time; the at least one entity causing a storage quota to be met; the at least one entity causing a storage quota to be approached; an operating system being determined to require an update to a later version; a software application being determined to require an update to a later version; a hardware sensor being activated; and a designated backup time being reached.

17. The non-transitory computer-readable medium of claim 15, wherein the associated action comprises at least one of: restarting the at least one entity; turning off the at least one entity; restarting the at least one application server; stopping the at least one application server; increasing a disk quota for a user associated with the at least one entity; changing a network routing pattern; installing a software patch; rescheduling a reminder for a later date; alerting the at least one entity regarding a condition at the at least one application server; performing an electronic purchase; activating fire suppression measures; and initiating a backup.

18. The non-transitory computer-readable medium of claim 15, wherein the log entry includes at least one category of data about the logging event comprising at least one of: timestamp, user name, application name, device name, and event description.

19. The non-transitory computer-readable medium of claim 18, further comprising executable instructions operable to cause the computing device to:
format the interactive display page, for display at the administrative user console, a plurality of log entries, wherein the plurality of log entries can be sorted based on the at least one category of data selectable by the administrative user at the administrative user console; and
responsive to a selection of the at least one category of data from the administrative user console, sort the plurality of log entries for display.

20. The non-transitory computer-readable medium of claim 18, further comprising executable instructions operable to cause the computing device to:
format the interactive display page, for display at the administrative user console, a plurality of log entries, wherein the plurality of log entries can be filtered based on information in the at least one category of data selectable by the administrative user at the administrative user console; and
responsive to a selection of the at least one category of data from the administrative user console, filter the plurality of log entries for display.
